(19) United States
(12) Patent Application Publication
(10) Pub. No.: US 2026/0368407 A1
(43) Pub. Date: Nov. 19, 2026

(54) REPRESENTATIVE SWITCHING ACTIVITY

(71) Applicant: Arm Limited, Cambridge (GB)

(72) Inventors: Pierre-Alexandre BOU-ACH, Trondheim (NO); Carl Erik Joakim SIMONSSON, Trondheim (NO)

(21) Appl. No.: 19/207,040

(22) Filed: May 13, 2025

(51) Int. Cl. G06F 30/373; G06F 119/06

(52) U.S. Cl. CPC G06F 30/373; G06F 2119/06

(57) ABSTRACT

Devices, systems, methods, and computer program products include generating synthetic switching activity data based on an analysis of two or more input switching activity data, such that the synthetic switching activity data is representative of the two or more input switching activity data for one or more modules of the circuit design to be analyzed.

### FIELD

The present disclosure generally relates to generating representative switching activity for modules of a circuit design.

### BACKGROUND

Many devices include circuitry that are operable to control and provide the functionality of the device. The circuitry may include many different modules and sub-modules, such as a central processing unit (CPU), a graphics processing unit (GPU) with a Texture Mapper unit, a Load/Store Cache unit, and an Execution Engine, a main memory, and so on, where each module in the circuitry dissipates power during operation. Depending on the use of the circuitry and the device containing the circuitry, the power dissipation may be of particular importance, for example, in small or mobile devices where power supply and/or cooling may be significantly limited.

One conventional approach for determining the power dissipation of circuitry is to analyze the switching activity of the circuitry by using, for example, performance counters to count the number of transitions (e.g. transitioning from high to low, or low to high) each module of the circuitry performs for one or more given tests. These performance counters provide an indication of how a particular test impacts a circuit design, but requires additional hardware, i.e. the performance counters, to be positioned in the circuitry and at a limited number of locations in the circuitry, which cannot be positioned at all and every position of interest in the circuit.

A further conventional approach is to execute switching activity files relating to specific industry standard tests (or benchmarks) on the circuitry. There are numerous industry standard tests of varying durations and targeting different, or similar, modules of a circuit design. The industry standard tests aim to “stress” the circuitry to a level greater than the “normal” operation of the circuitry to ensure that the circuitry can operate as expected. However, running several industry standard tests is a time-consuming process, where each industry standard test may target only a certain number of modules, be of different durations, and so on.

Thus, it is beneficial to determine and optimize the power dissipation of circuitry, in particular, for mobile devices, in a more efficient and effective manner. The present disclosure seeks to address, at least in part, the above-described disadvantages and drawbacks of the conventional approaches.

### SUMMARY

According to a first aspect of the present disclosure there is provided a method comprising: obtaining one or more modules relating to a circuit design to be analyzed; obtaining two or more input switching activity data, wherein the two or more input switching activity data include switching activity for at least one of the one or more modules of the circuit to be analyzed; analyzing the two or more input switching activity data to identify switching activity relating to the one or more modules of the circuit design to be analyzed; and generating a synthetic switching activity data based on the analysis of the two or more input switching activity data, wherein the synthetic switching activity data is representative of the two or more input switching activity data for the one or more modules of the circuit design to be analyzed.

In some embodiments. the obtained two or more input switching activity data may be selected from a plurality of potential input switching activity data based on a degree of similarity between the modules included in the potential input switching activity data and the modules of the circuit to be analyzed.

In some embodiments, the switching activity data may form at least part of a switching activity file and the synthetic switching data may form at least part of a synthetic switching activity file.

In some embodiments, generating the synthetic switching data may comprise: merging the identified switching activity for the one or more modules of the circuit design to be analyzed from the two or more input switching activity data, to generate a single representative switching activity for each module of the circuit design to be analyzed.

In some embodiments, merging the identified switching activity may include determining an average of the identified switching activity for each module of the circuit design to be analyzed from the two or more input switching activity data.

In some embodiments, obtaining the one or more modules relating to the circuit design to be analyzed may comprise: obtaining all of the modules relating to the circuit design to be analyzed; or obtaining a subset of the modules of the circuit design to be analyzed.

In some embodiments, the subset of modules may be selected by a user.

In some embodiments, the method may further comprise: executing the synthetic switching activity data on the circuit design to be analyzed; and analyzing a power dissipation of the circuit design to be analyzed based on the execution of the synthetic switching activity data.

In some embodiments, the method may further comprise: optimizing the circuit design based on the analysis of the power dissipation.

In some embodiments, generating the synthetic switching activity data may further comprise: normalizing the identified switching activity for each module of the circuit design to be analyzed across the two or more input switching activity data.

In some embodiments, the identified switching activity may be normalized with respect to a duration of the switching activity in each input switching activity data.

In some embodiments, the switching activity may be a toggle count, wherein each toggle count may indicate a transition of a signal from high to low, or from low to high.

In some embodiments, the method may further comprise: identifying one or more modules of the circuit design for which the identified switching activity for the one or more modules of the circuit design in the input switching data is below a threshold; and modifying the generated synthetic switching activity data to include switching activity for the identified one or more modules.

In some embodiments, the method may further comprise: defining one or more weights for one or more modules of the circuit design to be analyzed; and generating the synthetic switching activity data may further include applying the defined weights to the identified switching activity for the one or more modules of the circuit design to be analyzed.

In some embodiments, the generated synthetic switching activity data may include one or more vectors, wherein each vector may include synthetic switching activity for a module of the circuit design to be analyzed.

In some embodiments, the method may further comprise: generating a visualization and/or a report of the identified switching activity relating to the one or more modules of the circuit design to be analyzed.

In some embodiments, each module of the circuit design to be analyzed may be represented by a hardware description language code structure.

In some embodiments, identifying switching activity relating to the one or more modules may comprise mapping the switching activity of the two or more input switching activity files to each module's hardware description language code structure.

According to a second aspect of the present disclosure there is provided a computer program product comprising computer readable executable code which, when executed by a processor, cause the processor to: obtain one or more modules relating to a circuit design to be analyzed; obtain two or more input switching activity data, wherein the two or more input switching activity data include switching activity for at least one of the one or more modules of the circuit to be analyzed; analyze the two or more input switching activity data to identify switching activity relating to the one or more modules of the circuit design to be analyzed; and generate a synthetic switching activity data based on the analysis of the two or more input switching activity data, wherein the synthetic switching activity data is representative of the two or more input switching activity data for the one or more modules of the integrated circuit design to be analyzed.

In some embodiments, the obtained two or more input switching activity data may be selected from a plurality of potential input switching activity data based on a degree of similarity between the modules included in the potential input switching activity data and the modules of the circuit to be analyzed.

In some embodiments, the switching activity data may form at least part of a switching activity file and the synthetic switching data may form at least part of a synthetic switching activity file.

In some embodiments, the computer program product may further cause the processor to: merge the identified switching activity for the one or more modules of the circuit design to be analyzed from the two or more input switching activity data, to generate a single representative switching activity for each module of the circuit design to be analyzed.

In some embodiments, the computer program product may further cause the processor to: determine an average of the identified switching activity for each module of the circuit design to be analyzed from the two or more input switching activity data.

In some embodiments, the computer program product may further cause the processor to: obtain all of the modules relating to the circuit design to be analyzed; or obtain a subset of the modules of the circuit design to be analyzed.

In some embodiments, the subset of modules may be selected by a user.

In some embodiments, the computer program product may further cause the processor to: execute the synthetic switching activity data on the circuit design to be analyzed; and analyze a power dissipation of the circuit design to be analyzed based on the execution of the synthetic switching activity data.

In some embodiments, the computer program product may further cause the processor to: optimize the circuit design based on the analysis of the power dissipation.

In some embodiments, the computer program product may further cause the processor to: normalize the identified switching activity for each module of the circuit design to be analyzed across the two or more input switching activity data.

In some embodiments, the computer program product may further cause the processor to: identify one or more modules of the circuit design for which the identified switching activity for the one or more modules of the circuit design in the input switching data is below a threshold; and modify the generated synthetic switching activity file to include switching activity for the identified one or more modules.

In some embodiments, the computer program product may further cause the processor to: define one or more weights for at least one of the one or more modules of the circuit design to be analyzed; and apply the defined weights to the identified switching activity for the at least one of the one or more modules of the circuit design to be analyzed.

In some embodiments, the computer program product may further cause the processor to: generate a visualization and/or a report of the identified switching activity relating to the one or more modules of the circuit design to be analyzed.

In some embodiments, each module of the circuit design to be analyzed may be represented by a hardware description language code structure, and may further cause the processor to: map the switching activity of the two or more input switching activity file to each module's hardware description language code structure.

According to a third aspect of the present disclosure there is provided a system comprising: a processing device; and a memory; the memory storing instructions that, when executed, cause the processing device to implement a method according to the first aspect.

According to a fourth aspect of the present disclosure there is provided a circuit optimized for power dissipation, wherein the circuit comprises one or more modules and the circuit is optimized for power dissipation by: obtaining one or more modules relating to a circuit design to be analyzed; obtaining two or more input switching activity data, wherein the two or more input switching activity data include switching activity for at least one of the one or more modules of the circuit to be analyzed; analyzing the two or more input switching activity data to identify switching activity relating to the one or more modules of the circuit design to be analyzed; generating a synthetic switching activity data based on the analysis of the two or more input switching activity files, wherein the synthetic switching activity data is representative of the two or more input switching activity data for the one or more modules of the integrated circuit design to be analyzed; executing the synthetic switching activity data on the circuit design to be analyzed; analyzing a power dissipation of the circuit design to be analyzed based on the execution of the synthetic switching activity data; and optimizing the circuit design based on the analysis of the power dissipation.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### DRAWINGS

Embodiments of the present disclosure will now be described, by way of example only, and with reference to the accompanying drawings, in which:

FIG. 1 shows a simplified example of applying a set of tests to several modules.

FIG. 2 shows illustratively and schematically a system according to one or more embodiments of the present disclosure.

FIG. 3 shows a flow chart of a method according to one or more embodiments of the present disclosure.

### DESCRIPTION

Electronic devices include circuitry that are operable to control and provide the functionality of the device. The circuitry may include many different modules and associated sub-modules. For example, a central processing unit (CPU) module may include sub-modules such as instruction fetch, instruction decoder, execution unit, write back unit, floating point unit, caches, and so on, and a graphics processing unit (GPU) module may include sub-modules such as Texture mapper, Execution engine, Load/Store cache, Fragment, Tiler, L2 Cache, local interconnect, and so on. For the purposes of this disclosure, modules and sub-modules will be collectively referred to as modules. The modules are primarily implemented by hardware and, during operation of the circuitry, each module dissipates power, typically when a signal transitions from high to low, or vice versa. Depending on the purpose or functionality of the circuitry and the device containing the circuitry, the power dissipation may be of particular importance, for example, in small or mobile devices where power supply and/or cooling may be significantly limited.

As mentioned above, it is known to execute switching activity files relating to specific industry standard tests (or benchmarks) on the circuitry, or on a virtual implementation, or representation, of the circuitry, for example, using a hardware description language such as a Register Transfer Level (RTL) hardware description language (e.g. Verilog), in order to test the operability and resilience of the circuitry in the device they operate within. There are numerous industry standard tests of varying durations and targeting different, or similar, modules of a circuit design. For example, in relation to graphics processing such industry standard tests include, amongst others, GFXBench which is directed to testing performance, visual fidelity and battery life, 3DMark which is directed to testing gaming performance, and AnTuTu, which is directed to an all-around mobile benchmark. Each of the industry standard tests may include a number of individual tests that are grouped together to form the industry standard test. The industry standard tests aim to effectively “stress” the circuitry to a level greater than the “normal” operation of the circuitry to ensure that the circuitry can operate as expected and remain within design limitations and requirements. However, running several industry standard tests is a time-consuming process, as there are typically tens, if not hundreds, of tests (depending on the circuitry functionality and purpose), where each industry standard test may target only a certain number of modules that may be of overlapping scope, be of different durations, may insufficiently test one or more modules of the circuitry, and so on.

The Applicants have recognized that the existing techniques for analyzing a circuit design by running, or executing, a vast number of tests is inefficient and may be ineffective in relation to testing the modules of a circuit design, in particular in relation to power dissipation.

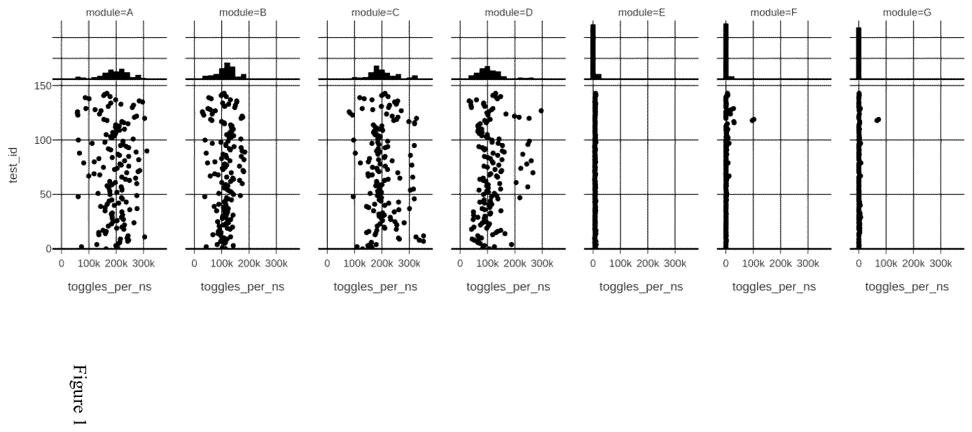

FIG. 1 shows schematically a simplified example of applying a set of industry standard tests to a circuit design that includes seven modules (labelled module A to module G). In this example the modules (including sub-modules) are defined, or described, using the RTL hardware description language. The tests are given a test_id, which in this example ranges from test_0 to test_150 on the Y-axis of the plots shown for each module, wherein each test forms part of, or corresponds to, one industry standard test. The X-axis of the plots shown for each module indicates the number of toggles (where a toggle is a transition from low to high, or from high to low) per nanosecond (ns).

As shown in FIG. 1, the multitude of tests significantly overlap and test the first four modules shown, i.e. module_A to module_D to a significant extent. Whilst in contrast, the multitude of tests do not test module_E and only a couple of the multitude of tests test the remaining two modules, i.e. module_F and module_G to any extent.

Accordingly, it is inefficient and time-consuming to execute, or run, all of the industry standard tests on a given circuitry that includes a number of modules. The Applicants have therefore recognized the need to provide an improved and more efficient process of testing the modules of a given circuitry design, in particular in relation to power dissipation.

The techniques and technology described in the following embodiments of the present disclosure equally apply to any circuit design having any functionality, for any purpose, and in any technology field. For example, the circuit design may be applied to the field of graphics processing where the circuit design includes modules relevant to graphics processing, such as, a graphics processing unit (GPU), a GPU Tiler, a main memory, a cache, an arithmetic logic unit (ALU), a Texture Mapper unit, a Load/Store Cache unit, an Execution Engine, and so on. Typically, a module is a hardware component (which may additionally include software, firmware, etc.) that receives, processes, and/or transmits signals (either analogue or digital signals), wherein the signals will transition (or toggle) between low to high (i.e. from 0 to 1) and between high to low (i.e. from 1 to 0).

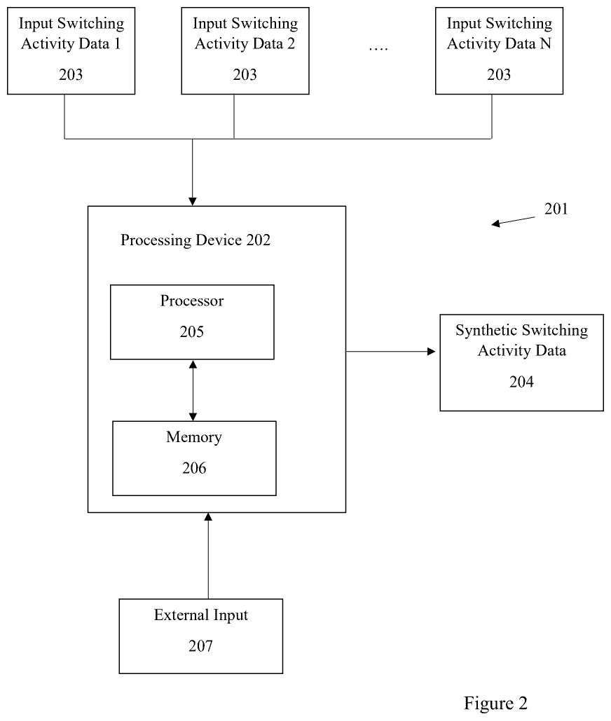

With reference to FIG. 2, there is shown illustratively and schematically a system for implementing the embodiments of the present disclosure. The system 201 includes a processing device 202 that includes, for example, a processor 205, a memory 206, external input means 207 (e.g. keyboard, mouse, server, database, etc.), a display, and so on, (e.g. a computing device, etc).

The processing device 202 receives, or obtains, as an input a circuit design to be analyzed where the circuit to be analyzed includes one or more modules, where a given module may further include, or be associated with, additional sub-modules. The modules (and associated sub-modules) may be defined by a suitable description such as the RTL hardware description language. The input circuit design may be provided as a hierarchy of modules (and any associated sub-modules). In embodiments, the processing device 202 may optionally receive, as an input, a user defined selection of one or more modules (which may include or be directed to sub-modules) of the circuit design to be analyzed. Accordingly, a user can select a subset of modules of the circuit design that are to be analyzed, for example, those modules and/or sub-modules that are of most interest.

The processing device 202 further receives or obtains, as an input, a number of (at least two) switching activity data 203, wherein the input switching activity data may form at least part of a switching activity file, and wherein the input switching activity data 203 relates to, for example, benchmark tests (e.g. industry standard tests), or other predefined tests, for a circuit and include a plurality of switching activity for a number of modules. The processing device 202 may receive, or obtain, the two or more input switching activity data from an external input source 207, e.g. a server, database, memory device, and so on, or from an internal source, e.g. a local memory, a local database, and so on. The processing device 202 may receive a selection of the tests to obtain the switching activity for, e.g., from a user input, or may determine (e.g. automatically) the relevant or appropriate tests to obtain the switching activity for based on the modules of the circuit design to be analyzed. The tests, and therefore the associated switching activity data may be selected, either manually or automatically, from a plurality of potential tests and associated switching activity data, based at least in part on a degree of similarity between the modules included in the potential input switching activity data and the modules of the circuit to be analyzed. For example, the degree of similarity may be based on a predefined threshold between the modules of the tests and the modules in the circuit to be analyzed. However, as will be appreciated, other methods of determining the degree of similarity may of course be implemented.

Each test and the corresponding switching activity data may include switching activity for the same and/or different modules of a circuit. Each test may be directed to a different purpose, e.g. testing different aspects or functionality of a circuit design, however, each different purpose may include overlapping modules to other tests, different modules to other tests, or any combination thereof.

The input switching activity data may include several parameters and information defining the switching activity for the modules relevant to the test corresponding to the switching activity data. The switching activity typically includes information on a number of transitions, which may also be referred to as toggles, for a given duration for each module. For example, for each port or net (where a net refers to a connection) of each module the switching activity file includes information regarding a toggle count (TC), the time the signal is high, e.g. 1, (T1) and the time the signal is low, e.g. 0, (T 0). As will be appreciated, the switching activity file may include any further information as necessary.

Each test may include switching activity that is defined differently for one or more modules, for example, with different durations of switching activity. Therefore, the processing device may on receiving the input switching activity data (or during the analysis of the input switching activity files, or during the generation of the synthetic switching activity file, both of which are described in more detail below) normalize the switching activity of each of the input switching activity data. For example, the switching activity may be normalized across the input switching activity data by converting the switching activity for each module to a consistent number of transitions (or toggles) per unit of time, where the unit of time may be, for example, nanosecond (ns), microseconds (ms), or any other suitable unit of time. However, as will be appreciated, other methods of normalizing the switching activity across the input switching activity data for each module for consistency are of course possible.

Any number of the one or more modules of the circuit design to be analyzed may be included in each one or more of the tests represented by the input switching activity data. However, as will be appreciated not all of the modules of the circuit design to be analyzed may be included in the tests represented by the input switching activity data.

The processing device 202 analyzes the two or more input switching activity data 203 to identify switching activity relating to one or more of the modules of the circuit design to be analyzed (or one or more of a subset of the modules if a user has selected a subset of the modules) from each of the two or more switching activity data. In embodiments, the modules are defined by a hardware description language (e.g. RTL) representation of the hardware design of the circuit to be analyzed and the processing device may identify the relevant switching activity of the two or more input switching activity data 203 by mapping the switching activity of the two or more input switching activity data 203 to the modules (or selected modules) of the circuit design based on the hardware description language code structure of the modules.

Alternatively, or additionally, the analysis of the two or more input switching activity data 203 may initially include searching the input switching activity data for the presence of each of the modules of the circuit design to be analyzed (or a subset of the modules if a user has selected a subset of the modules), and/or comparing the modules of the circuit design to be analyzed (or a subset of the modules if a user has selected a subset of the modules) to the modules present in each of the input switching activity data.

However, as will be appreciated other methods for identifying the modules of the circuit design to be analyzed within the two or more input switching activity data. Furthermore, the processing device 202 may identify or map the switching activity for each module of the circuit to be analyzed simultaneously or consecutively.

For example, in the case where the circuit design is directed to GPU having a GPU Tiler module, the GPU Tiler module will have associated with it a number of sub-modules each operable to perform particular functionality of the GPU Tiler module, wherein each module may be defined, or represented by, a hardware description language code structure (e.g. RTL). To analyze the switching activity of the GPU Tiler module as a whole (or of particular sub-modules) the processing device may analyze the switching activity of the two or more input switching activity data to identify the relevant switching activity of the GPU Tiler module and/or the associated sub-modules, for example, by mapping the GPU Tiler switching activity in the input switching activity files to the GPU Tiler module and the associated sub-modules represented by the hardware description language code structure to obtain the relevant information to be able to subsequently optimize the circuit design, for example, the power dissipation. If the user has selected one or more of the GPU Tiler sub-modules as being of particular interest then the individual switching activity for the selected sub-module may be identified and obtained separately to the switching activity for the GPU Tiler module as a whole to enable the user to view the switching activity for the selected sub-module in parallel to the switching activity for the GPU Tiler module as a whole.

The processing device 202 then generates a synthetic switching activity data 204 based on the analysis of the two or more input switching activity data 203. A synthetic switching activity data refers to a further new and purposefully generated switching activity data based on the identified switching activity for the modules of the circuit design to be analyzed. The synthetic switching activity data may form at least part of a synthetic switching activity file. The synthetic switching activity data generated is, at least, representative of the two or more input switching activity data for the modules of the circuit design to be analyzed. This is advantageous as it negates the need to execute multiple different tests (where each test is represented by an associated switching activity data) which the Applicants have recognized as being a time-consuming and inefficient process to test a circuit design.

The synthetic switching activity data 204 may be generated by one or more methods being applied independently, or in any combination thereof, to the analysis of the two or more input switching activity data.

For example, generating the synthetic switching activity data 204 may include merging the identified switching activity for a given module from each of the input switching activity data that include switching activity for the given module. The merging of the switching activity may include one or more (e.g. independently or in any combination thereof) of taking the highest number of switching activity (e.g. highest number of transitions) in any given switching activity data for the given module, taking the longest duration of switching activity in any given switching activity data for the given module, taking an average of the number of transitions and/or the duration of switching activity in the switching activity data for the given module, or combining the number of transitions and/or the longest duration of switching activity in the switching activity data for the given module. Other methods are of course possible for merging the identified switching activity for a given module from each of the switching activity data that include switching activity for the given module, which can be implemented independently or in any combination thereof.

Generating the synthetic switching activity data 204 may alternatively, or additionally, include identifying an overlap of switching activity for a given module between the two or more switching activity data (for example, by comparing the switching activity for a given module present in two or more of the switching activity data) and taking a subset of the overlapping switching activity from one or more of the switching activity data.

Generating the synthetic switching activity data 204 may alternatively, or additionally, include identifying one or more modules of the circuit design to be analyzed for which there is little or no switching activity in the two or more input switching activity data. For example, the processing device may determine that a total number and/or a total duration of switching activity in the two or more switching activity data for the given module is below a respective predetermined threshold. For example, the threshold may be a value (e.g. a percentage, a total number and/or duration of toggles, and so on) applied to each module, where the same predetermined threshold value may be applied across all modules, or different predetermined threshold values may be applied dependent on and specific to each of the module(s) of the circuit design to be analyzed. The predetermined threshold may alternatively, or additionally, be based on the expected average representative switching activity for each of the one or more modules, or based on a comparison of the switching activity of the modules. As will be appreciated, other methods of determining an appropriate predetermined threshold are of course possible. If one or more modules are identified as having switching activity below the applicable predetermined threshold then the synthetic switching activity data may be modified, either automatically or based on user input, to include a greater, or required, number and/or duration of switching activity for the identified one or more modules of the circuit design to be analyzed.

Generating the synthetic switching activity data 204 may alternatively, or additionally, be based on one or more predefined weights to be applied to the switching activity for one or more selected modules of the circuit design to be analyzed. For example, a user may require certain modules to be subject to a higher level of testing, or conversely a lower level of testing would be appropriate. Thus, in this case, the user may define weights to be applied to one or more selected modules to increase, or decrease, the switching activity (e.g. in terms of the total number and/or the duration). The processing device 202 may then apply the defined weights to the selected one or more modules to modify, or alter, the switching activity for the selected one or more modules according to the predefined weights. This advantageously enables, if needed, the user to target particular modules to increase, or decrease, the switching activity to be applied to those modules, thereby enabling particular modules of interest to be subject to greater testing and other modules of less interest to be subject to less testing further enhancing the efficiency of the testing overall.

Generating the synthetic switching activity data 204 may alternatively, or additionally, be based on one or more formulas, or rules, that may be user-defined which can enable a user to define particular criteria for the generation of the synthetic switching activity data. The formulas or rules may be defined based on the circuit to be analyzed, the functionality of the modules, testing requirements, or on any other factor as required in order to generate a representative synthetic switching activity data.

Additionally, or alternatively, the synthetic switching activity data 204 may be generated using, at least in part, artificial intelligence (AI) techniques such as neural networks, machine learning, and so on. The AI techniques may be implemented to analyze the switching activity of the modules of the circuit design in the two or more input switching activity data in order to apply further intelligence to the generation of the synthetic switching activity data.

The embodiments of the present disclosure are advantageous as the efficiency and effectiveness of the testing of the circuit design being analyzed can be significantly improved by generating a single switching activity data that is representative of the two or more input switching activity data.

The generated synthetic switching activity data 204 may then be stored in a memory of the processing device and or output to an external memory device. The generated synthetic switching activity data may be in any suitable format and/or be of any suitable file type to enable the generated synthetic switching activity data to be executed on the circuit to be analyzed. For example, the generated synthetic switching activity data may be, or form at least part of, a Switch Activity Interchange Format (SAIF) file which is an ASCII file that includes, for each port or net of each module (which may be defined or represented by hardware description language), information regarding a toggle count (TC), the time the signal is high, e.g. 1, (T1) and the time the signal is low, e.g. 0, (T 0). The information generated for the synthetic switching activity data may be in the form of a vector, wherein the synthetic switching activity data may include a vector per module, a vector per sub-module, or a vector per port/net of each module/sub-module. As will be appreciated, the switching activity data may include any further information as necessary.

Once the synthetic switching activity data 204 is generated, the synthetic switching activity data 204 may be utilized to measure, calculate, or estimate, the power dissipation of one or more modules of the circuit design to be analyzed.

For example, the generated synthetic switching activity data may be executed on a physical implementation of the circuit design (e.g. a prototype of the circuit), or on a virtual implementation (e.g. a software representation, or model, of the circuit, for example, using a hardware description language), and the power dissipation, or energy efficiency, of the circuit during the execution of the generated synthetic switching activity data may be measured (e.g. using power measurement tools), calculated, and/or estimated, for one or more, or each, port, net, pin and/or cell of the circuit design.

One or more tools, such as Electronic Design Automation (EDA) tools, may alternatively, or additionally, be utilized to calculate, or estimate, the power dissipation for each port, net, pin and/or cell of the circuit design. For example, power dissipation may be measured or estimated using an implementation of a circuit, for example, by a hardware description language, with an integrated engine of a tool, e.g. an EDA tool. As will be appreciated, other factors in addition to power dissipation may also be measured, calculated, and/or estimated during the execution of the generated synthetic switching activity data in order to further optimize the circuit design.

The processing device 202 may additionally generate reports, or visualizations, showing the modules of the circuit to be analyzed switching activity for each of the two or more input switching activity data and/or the generated synthetic switching activity data taking in to account any normalization of the switching activity and any user defined weights. The reports and/or visualizations may enable a user to understand and view which modules of the design are being tested by each of the two or more input switching activity data and/or the generated synthetic switching activity data, and provide an indication of the degree to which modules of the circuit design are being tested. Thus, it is possible for a user to identify modules of the circuit design that may not be sufficiently tested and/or to identify modules that are of a particular importance, or relevance to the power dissipation.

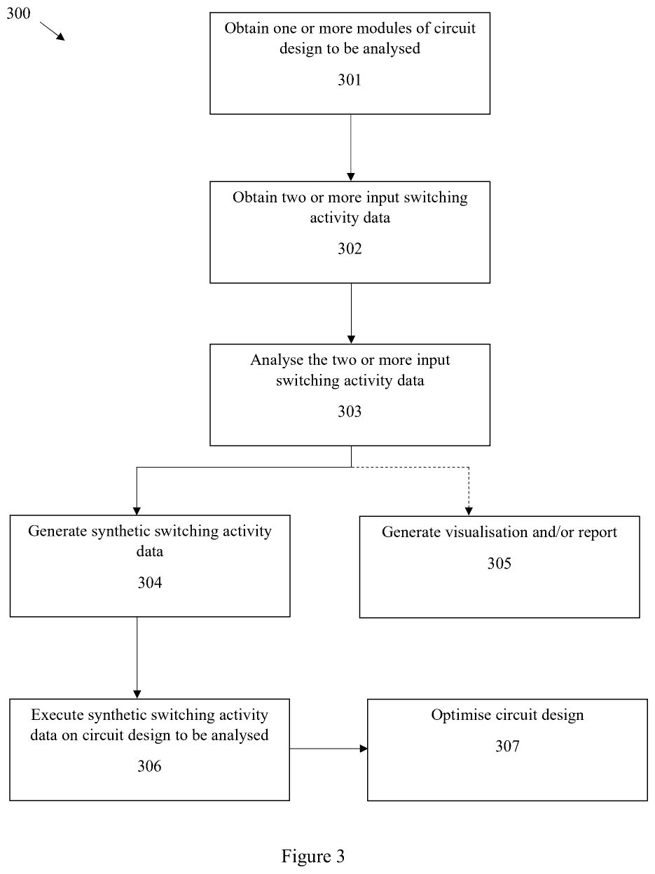

FIG. 3 shows a flow chart 300 of the method according to one or more embodiments of the present disclosure. The method receives at 301 one or more modules of circuit design to be analyzed, wherein the modules may be represented by a hardware description language code structure (e.g. RTL). The one or more modules may include either all of the modules (and any associated sub-modules) or a user defined selection of modules/sub-modules. The method further obtains, or receives, two or more input switching activity data which include switching activity for at least one of the one or more modules of the circuit to be analyzed at 302. At 303 the two or more input switching activity data are analyzed to identify the switching activity relating to the received modules of the circuit design to be analyzed, for example, by mapping the switching activity of the input switching activity files to the hardware description language code structure (e.g. RTL) of the modules, or selected modules.

At 304, a synthetic switching activity data is generated based on the identified switching activity relating to the received modules of the circuit design to be analyzed. For example, for each module of the circuit design the related identified switching activity across the two or more input switching activity data can be merged, for example, an average of the number of toggles (or transitions) per unit of time (e.g. nanoseconds) for a given module in each of the input switching activity data, to generate the switching activity for the module which can then be stored, or recorded, in the synthetic switching activity data for the module. However, other methods for generating the synthetic switching activity data based on the identified switching activity for each module are of course possible, such as those previously described hereinabove. The generated switching activity for each module in the synthetic switching activity data may further be based on any user defined weights and/or a normalization of the switching activity across the input switching activity data.

Optionally, at 305, a report and/or a visualization may be created showing the switching activity for the modules of the circuit design in the different two or more input switching activity data, which may take into account, or be further based upon, any user defined weights for one or more of the modules of the circuit design to be analyzed and/or a normalization of the switching activity across the two or more input switching activity data.

Once the synthetic switching activity data 204 has been generated then it may be utilized to determine, or estimate, a power dissipation of one or more modules of the circuit design to be analyzed in 306. For example, the generated synthetic switching activity data may be run, or executed, on a physical implementation of the circuit design, e.g. a prototype of the circuit, on a virtual implementation of the circuit in software, on a design tool, or any combination thereof, in order to determine, or estimate, the power dissipation of one or more modules of the circuit design.

Once the power dissipation of the relevant modules of the circuit design have been determined or estimated, then the circuit design can be optimized for, at least, power dissipation in 307. For example, optimization (e.g. power dissipation, but may also be for performance and/or area) can be performed using targeted user-defined commands in EDA tools, and/or by one or more algorithms applied by EDA tools. The targeted user-defined commands and/or the one or more algorithms considers the synthetic switching activity and performs power dissipation optimizations, which may further consider one or more trade-offs for other aspects such as performance or area depending on one or more criteria, or requirements, relating to, for example, Power, Performance and Area (PPA). The PPA criteria, or requirements may be user defined or generated based on, for example, neural networks. The more precise and relevant the generated synthetic switching activity is, the better the optimizations as the targeted user-defined commands and/or the one or more algorithms can be focussed on optimizing power in the circuit design, thereby providing a circuit with better power dissipation metrics.

FIG. 3 is an example flow chart of the method of the present disclosure. However, as will be appreciated, the present disclosure is not limited by the order or number of stages.

The methods in accordance with the technology described herein may be implemented at least partially using software, e.g. computer programs. It will thus be seen that in further embodiments the technology described herein comprises computer software specifically adapted to carry out the methods described herein when installed on a data processor, a computer program element comprising computer software code portions for performing the methods described herein when the program element is run on a data processor, and a computer program comprising code adapted to perform all the steps of a method or of the methods described herein when the program is run on a data processing system.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD-ROM, RAM, flash memory, or disk.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over a tangible medium, including but not limited to optical or analogue communications lines. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic or optical. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

The present disclosure also relates to circuitry that is optimized for power dissipation utilizing the advantageous techniques and technology of the present disclosure.

The foregoing detailed description has been presented for the purposes of illustration and description. It is not intended to be exhaustive or to limit the invention to the precise form disclosed. Many modifications and variations are possible in the light of the above teaching. The described embodiments were chosen in order to best explain the principles of the technology described herein and its practical applications, to thereby enable others skilled in the art to best utilize the technology described herein, in various embodiments and with various modifications as are suited to the particular use contemplated. It is intended that the scope be defined by the claims appended hereto.

1. A method comprising:
obtaining one or more modules relating to a circuit design to be analyzed;
obtaining two or more input switching activity data, wherein the two or more input switching activity data include switching activity for at least one of the one or more modules of the circuit to be analyzed;
analyzing the two or more input switching activity data to identify switching activity relating to the one or more modules of the circuit design to be analyzed; and
generating a synthetic switching activity data based on the analysis of the two or more input switching activity data, wherein the synthetic switching activity data is representative of the two or more input switching activity data for the one or more modules of the circuit design to be analyzed.

2. The method of claim 1, wherein the obtained two or more input switching activity data are selected from a plurality of potential input switching activity data based on a degree of similarity between the modules included in the potential input switching activity data and the modules of the circuit to be analyzed.

3. The method of claim 1, wherein the switching activity data forms at least part of a switching activity file and the synthetic switching data forms at least part of a synthetic switching activity file.

4. The method of claim 1, wherein generating the synthetic switching data comprises:
merging the identified switching activity for the one or more modules of the circuit design to be analyzed from the two or more input switching activity data, to generate a single representative switching activity for each module of the circuit design to be analyzed; and
wherein merging the identified switching activity includes determining an average of the identified switching activity for each module of the circuit design to be analyzed from the two or more input switching activity data.

5. The method of claim 1, wherein obtaining the one or more modules relating to the circuit design to be analyzed comprises:
obtaining all of the modules relating to the circuit design to be analyzed; or
obtaining a subset of the modules of the circuit design to be analyzed;
wherein the subset of modules is selected by a user.

6. The method of claim 1, further comprising:
executing the synthetic switching activity data on the circuit design to be analyzed;
analyzing a power dissipation of the circuit design to be analyzed based on the execution of the synthetic switching activity data; and
optimizing the circuit design based on the analysis of the power dissipation.

7. The method of claim 1, wherein generating the synthetic switching activity data further comprises:
normalizing the identified switching activity for each module of the circuit design to be analyzed across the two or more input switching activity data; and
wherein the identified switching activity is normalized with respect to a duration of the switching activity in each input switching activity file.

8. The method of claim 1, further comprising:
identifying one or more modules of the circuit design for which the identified switching activity for the one or more modules of the circuit design in the input switching data is below a threshold; and
modifying the generated synthetic switching activity data to include switching activity for the identified one or more modules.

9. The method of claim 1, further comprising:
defining one or more weights for one or more modules of the circuit design to be analyzed; and
generating the synthetic switching activity data further includes applying the defined weights to the identified switching activity for the one or more modules of the circuit design to be analyzed.

10. The method of claim 1, wherein each module of the circuit design to be analyzed is represented by a hardware description language code structure; and
identifying switching activity relating to the one or more modules comprises:
mapping the switching activity of the two or more input switching activity data to each module's hardware description language code structure.

11. A computer program product comprising computer readable executable code which, when executed by a processor, cause the processor to:
obtain one or more modules relating to a circuit design to be analyzed;
obtain two or more input switching activity data, wherein the two or more input switching activity data include switching activity for at least one of the one or more modules of the circuit to be analyzed;
analyze the two or more input switching activity data to identify switching activity relating to the one or more modules of the circuit design to be analyzed; and
generate a synthetic switching activity data based on the analysis of the two or more input switching activity data, wherein the synthetic switching activity data is representative of the two or more input switching activity data for the one or more modules of the integrated circuit design to be analyzed.

12. The computer program product of claim 11, wherein the obtained two or more input switching activity data are selected from a plurality of potential input switching activity data based on a degree of similarity between the modules included in the potential input switching activity data and the modules of the circuit to be analyzed.

13. The computer program product of claim 11, further causes the processor to:
merge the identified switching activity for the one or more modules of the circuit design to be analyzed from the two or more input switching activity data, to generate a single representative switching activity for each module of the circuit design to be analyzed; and
determine an average of the identified switching activity for each module of the circuit design to be analyzed from the two or more input switching activity data.

14. The computer program product of claim 11, further causes the processor to:
obtain all of the modules relating to the circuit design to be analyzed; or
obtain a subset of the modules of the circuit design to be analyzed;
wherein the subset of modules is selected by a user.

15. The computer program product of claim 11, further causes the processor to:
execute the synthetic switching activity data on the circuit design to be analyzed; and
analyze a power dissipation of the circuit design to be analyzed based on the execution of the synthetic switching activity data; and
optimize the circuit design based on the analysis of the power dissipation.

16. The computer program product of claim 11, further causes the processor to:
normalize the identified switching activity for each module of the circuit design to be analyzed across the two or more input switching activity data; and
wherein the identified switching activity is normalized with respect to a duration of the switching activity in each input switching activity data.

17. The computer program product of claim 11, further causes the processor to:
identify one or more modules of the circuit design for which the identified switching activity for the one or more modules of the circuit design in the input switching data is below a threshold; and
modify the generated synthetic switching activity data to include switching activity for the identified one or more modules.

18. The computer program product of claim 11, further causes the processor to:
define one or more weights for at least one of the one or more modules of the circuit design to be analyzed; and
apply the defined weights to the identified switching activity for the at least one of the one or more modules of the circuit design to be analyzed.

19. The computer program product of claim 11, wherein each module of the circuit design to be analyzed is represented by a hardware description language code structure, and further causes the processor to:
map the switching activity of the two or more input switching activity data to each module's hardware description language code structure.

20. A circuit optimized for power dissipation, wherein the circuit comprises one or more modules and the circuit is optimized for power dissipation by:
obtaining one or more modules relating to a circuit design to be analyzed;
obtaining two or more input switching activity data, wherein the two or more input switching activity data include switching activity for at least one of the one or more modules of the circuit to be analyzed;
analyzing the two or more input switching activity data to identify switching activity relating to the one or more modules of the circuit design to be analyzed;
generating a synthetic switching activity data based on the analysis of the two or more input switching activity data, wherein the synthetic switching activity data is representative of the two or more input switching activity data for the one or more modules of the integrated circuit design to be analyzed;
executing the synthetic switching activity data on the circuit design to be analyzed;
analyzing a power dissipation of the circuit design to be analyzed based on the execution of the synthetic switching activity data; and
optimizing the circuit design based on the analysis of the power dissipation.
